(19) United States
(12) Patent Application Publication
(10) Pub. No.: US 2025/0137825 A1
(43) Pub. Date: May 1, 2025

(54) FLOW CONDITIONING ASSEMBLY WITH MICROMACHINED MASS FLOW SENSORS

(71) Applicants: Liji Huang, Santa Clara, CA (US); Chih-Chang Chen, Cupertino, CA (US)

(72) Inventors: Liji Huang, Santa Clara, CA (US); Chih-Chang Chen, Cupertino, CA (US)

(73) Assignee: Siargo Ltd., Santa Clara, CA (US)

(21) Appl. No.: 18/383,804

(22) Filed: Oct. 25, 2023

(51) Int. Cl. G01F 1/684; G01F 5/00

(52) U.S. Cl. CPC G01F 1/6842; G01F 5/00

(57) ABSTRACT

A flow conditioning assembly for a flow velocity and mass flow measurement apparatus utilizing micromachined flow sensing elements is disclosed for maintaining high metrological performance. The assembly introduces a flow profile shatter and redistribution mechanism before the flowing fluid enters the flow straightener and flow profiler combined flow conditioning. The assembly further removes the probability of flow clogging, has a low flow resistance, and relaxes the metrological requirements of the connecting pipework system. An alternative build with a bypass flow chamber with a flow redistribution channel allows the measurable flow velocity to extend to more than three times the configuration where the micromachined flow sensing elements are placed inside the center of the main flow channel.

### 1. FIELD OF THE INVENTION

This invention relates to micromachined silicon sensors or Micro Electro Mechanical Systems (MEMS) thermal mass flow sensing technology. This invention additionally provides the design and arrangement of micromachined thermal mass flow sensors and meters.

### 2. Description of the Related Art

Micromachined thermal mass flow meters have been widely used in automotive, medical, and other process monitoring and measurement in the past 30 years. Similar to the traditional thermal mass capillary meters or anemometers, the flow meters built with micromachines thermal mass flow sensors are also susceptible in their metrological performance, in particular for larger flow channels where the averaged flow rate will not be easily captured at a specific location where the sensor is placed. The reproducibility of thermal flow sensors is often undesirable in a large flow channel. As the footprint of the micromachined sensors is even smaller compared to its traditional counterpart, installation with a long straight pipe is often mandatory to maintain a reproducible flow profile. This makes it unrealistic for many applications. Nonetheless, the micromachined mass flow sensors can have a much higher degree of integration of the sensing elements, and they can have the potential to be operated with a very lower power or mobile power. The low power capability also improves the offset stability allowing it to improve its performance in process control. These advantages of micromachined mass flow sensors prompt more and more applications. Subsequently, demands for higher accuracy become imperative.

In a practical fluidic flow system, elbow-like pipes and valves are often necessary for the flow management in the pipework. These components would create turbulence and unpredictable flow velocity profiles whereas the flow measurement apparatus is calibrated in a carefully controlled stable flow pipework system. Therefore, the flow measurement apparatus could output results with large deviations or errors if the installation does not follow the strict pipework arrangement that is similar to that at the calibration for a specific measurement apparatus. To offer measurement accuracy, flow apparatus often has flow conditioning components installed at its inlet to force the fluidic flow to reproduce its flow profile at calibration after the conditioning components. There are several fluidic flow conditioning approaches for maintaining a stable flow profile inside a flow channel but the best approach is to combine a flow straightener and a flow profiler (Laws, E. M., Flow Conditioner, U.S. Pat. No. 5,762,107, Jun. 9, 1998). The straightener will remove the swirls and turbulent flow whilst the profiler will force the flow into the desired flow velocity profile. Nevertheless, for the micromachined flow sensors, the small footprint of the sensing elements makes the conventional flow conditioning approaches ineffective.

Several disclosures to improve the performance of the micromachined mass flow sensors have been proposed. One such effort is to place the micromachined sensing element at a divided channel that is separated at the inlet to form a branch channel and an introduction channel. In addition to the flow conditioning, this arrangement could also prevent some particle impact on the tiny sensing element (Kuzuyama, D. and Fujiwara, T., Flow-velocity Measurement Device, U.S. Pat. No. 7,284,423, Oct. 23, 2007). This arrangement, however, could only apply to a relatively small flow channel as the possible division of the channel is limited. It also requires the flow division in real applications to be the same at the calibration, but any inlet pressure changes will lead to unpredictable flow division. Consequently, the arrangement could only be used for low-pressure and low-precision measurement applications.

Since it is not feasible to place the micromachined sensor with a small footprint directly into the main channel to obtain a reproducible and stable measurement that represents the entire flow profile, a bypass design is therefore a natural choice. Speldrich J. et al. (Speldrich. J., Ricks, LF., Becke, C. S., and Feng, W., Flow Sensor Assembly with Integral Bypass Channel, U.S. Pat. No. 8,418,549, Apr. 16, 2013) disclosed a flow conditioning structure that divided the flow path where the micromachined sensing element is placed into three channels with equal size. Because of the tiny footprint, the structure can only be used for bypass measurement. However, the arrangement makes it difficult to arrange the same in the main flow pass, leading to the differential pressure across the said assembly being unstable at the different flow rate conditions. Hence the pressure-related uncertainties would be quite large for the measurements.

Another issue with the bypass design is that the tiny bypass channel may be clogged by some particles inside the flow fluid. To solve this issue, Hornung et al, (Hornung, M., Mayer, F., and Kuttel, C., Flow Sensor Arrangement, U.S. Pat. No. 9,146,143, Sep. 29, 2015) teach a bypass flow conditioning structure, particularly for micromachined flow sensors. In the disclosed flow conditioning embodiment, the main flow channel is filled with a structure that has multiple identical-sized pipes which increases the flow resistance that will enhance the sensitivity for the measurement in the bypass channel. To reduce the particles into the bypass channel, the inlet of the bypass channel is designed with its entrance pointed at an angle backward to the fluid flow direction. In such an arrangement as most of the particles will not change their moving directions with the flow medium, the chance for the particles to enter the bypass channel is therefore substantially reduced. In addition, the bypass channel is designed into a thin cylinder format that will have a significantly larger area compared to the conventional small bypass channel inlet. It will reduce the chance of clogging because of particles. However, this arrangement may not easily reduce liquid vapors because of their light mass, and cannot completely block the particles. For some applications that require a long service life, the reliability of such design would be still a concern.

The micromachined flow-sensing elements are mostly applied for flow in a small flow channel using a calorimetric sensing approach with limited flow velocity rangeability, particularly limited at the high flow regime. An anemometric approach is not preferred because the highly developed turbulent flow is more difficult to contain and its low flow velocity and mass flow detection is rather difficult. Nonetheless, quite some high flow velocity and mass flow measurement applications demand small flow measurement apparatuses with relatively small pressure loss that other traditional technologies cannot offer. An example is the flow control in the pneumatic automation process where the compressed air has a standard pressure of 400 kPa and above and the pipework system often has a small pipe size. This requires the flow measurement apparatus to be capable of high flow speed detection. Consequently, a new flow conditioning assembly or flow path design that can achieve high flow velocity and mass flow detection with the micromachined calorimetric sensing elements is very much desired for the micromachined flow sensing technology to extend its applications.

In many low-pressure fluidic flow measurements, pressure loss due to any flow conditioning structure would be problematic. Whereas a bypass design often requires a structure with large flow resistance that can force the flow inside the main channel into the small bypass channel. For example, in human respiratory detection, the exhale pressure would be quite low. The respiratory also has a large amount of water vapors. Another example is the fuel measurement for appliances where the fluid flow is designed at low pressure for safety reasons. The current flow conditioning arrangement for micromachined sensors in similar applications as the respiratory and home appliances is therefore undesired.

### SUMMARY OF THE INVENTION

It is therefore desired to provide the design of the flow conditioning assembly for a flow meter that utilizes the micromachined sensing element for the measurement. The said flow conditioning assembly will be able to reproduce the flow velocity and mass flow profile at the time of calibration or to maintain the metrological accuracy. The said flow conditioning assembly will further have a low flow resistance or a small pressure loss that can allow the measurement to be performed at low inlet pressure conditions. The said flow conditioning assembly will have ample space or a large enough measurement channel size in which the micromachined sensing element is installed, such that the clogging due to particles or vapors will be prevented from happening during complicated fluid flow measurement. The said flow conditioning assembly will be preferred to allow the removal of the straight pipework requirements for most of the flow measurement apparatus, such that the advantage of the small footprint of the micromachined flow sensing element could be applied where only limited space is available for installation. The said flow condition assembly will be preferred to be scalable and will have the capability to be installed in a wide range of flow channels such that the application limitation in a large pipework of a micromachined flow sensor can be removed. The said flow conditioning assembly will also be easy to install to the flow measurement channel and will allow easy access to necessary maintenance. Such said flow conditioning assembly will also be easily manufactured at a low cost for high-volume applications.

It is an object of the present invention to design the said flow conditioning assembly for micromachined flow sensing elements such that the measurement can reproduce the metrological performance at the calibration. The critical issue is to confine the fluidic flow such that the tiny footprint of the micromachined sensing elements can capture the measurand that will reproducibly yield the metrological results. For most of the practical measurements with an intended large dynamic range, the fluidic flow will have laminar, transitional, and turbulent flow. Each of these flow characteristics will depend on the conditions at the inlet, therefore metrological standard requires a pipework system with an inlet pipe that must be straight and have the same sized pipe diameter. The length of such a pipe can be up to 30 times the pipe diameter depending on the upstream conditions. For the said flow conditioning assembly, a disk is employed to manage the incoming flowing fluid. The flowing fluid with any of the above-mentioned characteristics will be shattered and forced to be redistributed at the edge of the disk. Consequently, this disclosure offers solutions to the measurement errors due to the uncertainties of the incoming fluid characteristics. For example, in the laminar flow regime, the fluid flow profile is parabolic. The center position of the parabolic at the inlet will be dependent on the inlet pipework configuration. In particular, for a soft pipe connection, the movement or even the vibration of the soft pipe will change the parabolic profile, making the measurement reproducibility impossible. Nonetheless, with the disclosed disk, any flow profile of the incoming fluid will be forced to change into the path of the disk edge. The buffer chamber behind the disk and subsequent flow profiler will then guide the incoming flow into the measurement channel with a reproducible flow profile. The disclosed disk on the other hand breaks swirls that may exist in the flowing fluid and serves as a pressure balancer that manages the pressure distribution in the laminar flow regime. The subsequent measurement channel is formed by the coaxial pipes of various sizes depending on the flow channel size of the apparatus. The micromachined sensing element is placed at the center of the center pipe of the coaxial configuration. This configuration will allow a stable flow across the entire flow channel and the center pipe will have the highest flow speed, while the length to the pipe diameter is relatively the longest which provides additional conditions for flow stability and sensitivity. The size of this coaxial configuration is scalable to the main flow channel size that is determined by the specified full-scale flow rate.

It is another object of the present invention that the flow conditioning assembly will have low differential pressure or small pressure loss for the measurement apparatus. It is known that in a bypass flow measurement apparatus, the main flow channel must be divided into multiple channels with an identical size that is equal or comparable to the size of the bypass channel to maintain flow reproducibility. This arrangement in the main flow channel is also named to be a laminar block. Since the bypass channel is often very small, the corresponding laminar block will create a large differential pressure or a large pressure loss. The said flow conditioning assembly removes the conventional bypass measurement arrangement for the micromachined sensing elements by placing the same into the main flow channel with a coaxial multi-pipe configuration. Consequently, the effective flow passing areas are substantially larger and the pressure drop by the said flow conditioning assembly is much lower. By comparing to some current products on the market for the same flow measurement range and pipework, the pressure loss by the said flow conditioning assembly is about one-tenth of the published data.

It is another object of the present invention that the said flow conditioning assembly will remove the concern for flow measurement channel clogging. The clogging will become apparent when the change in the size of the flow measurement channel due to foreign materials accumulation from the flowing fluid would be significant. For most of the products on the market with a bypass measurement channel design, the bypass channel size is mostly below two millimeters. Such a size can be easily altered if the flowing fluid is contaminated and the measurement apparatus has a long service time without being able to be maintained. For example, in pneumatic applications, the compressed air is inevitably having water and oil vapors. Deposition of the oil can create a smaller channel size or even block the channel resulting in significantly deviated measurement data or even failure. In the said arrangement of the flow conditioning assembly, the speed flow will encounter the disk at the inlet, heavy foreign materials will be slowed down and a significant portion such as heavy particles will be left at the lower part of the space under the disk. The center measurement channel of the coaxial configuration where the micromachined sensing elements are placed is designed to have a channel size three to ten times larger than the conventional bypass channel. The ample space of the coaxial measurement configuration will not be impacted by foreign materials accumulation. Further, the micromachined sensing elements are arranged such that the surface direction of the sensors is perpendicular to the fluid flow directions, the flowing flow at the highest speed would also on the other hand blow away any foreign materials possibly deposited at extremely low flow conditions.

It is another object of the present invention that the said flow conditioning assembly will allow the removal of the conventionally required long straight pipe in the pipework system for the flow measurement apparatus. The advantages of the small footprint of the flow measurement apparatus made with micromachined flow sensing elements are often offset by the required long straight pipe connected to the inlet of the apparatus. Today's system build often requires compact size and multiple controlling points. This trend makes the design of many systems that have flow apparatus a challenge for maintaining the metrological performance. The said flow conditioning offers a solution. The disk at the inlet will shatter the incoming flow profile and force the flow to redistribute along the circular edge of the disk in a thin cylinder formality. The buffer chamber behind the disk offers a low-pressure space that allows the flowing fluid to become less turbulent. The flow profiler ensures the flowing fluid forms the new profile before entering the measurement channel. Consequently, the said flow conditioning assembly will no longer depend on the straight pipe at the inlet to offer the reproducible flow profile for the measurement but rather it will force the flowing fluid to redistribute into the profile that is defined by the profiler and hence the requirement of a long straight pipe at the inlet for reproducibility is no longer needed. Any pipe including elbow pipes or valves can be applied right at the inlet of the flow measurement apparatus for the desired pipework system.

It is a further object of the present invention to allow the said flow conditioning assembly to be scalable such that it can be applied for flow measurement in the large pipework system. Micromachined flow-sensing elements are mostly packaged into a small bypass channel and applied for low-flow measurements in a small flow channel. Applications with micromachined flow sensing elements are also not used for custody transfer or tariff purposes for which the flow channel is often large. One of the reasons is that the conventional bypass flow channel design is nonsymmetrical, scaling up and the measurement channel where the micromachined flow elements are located is non-scalable. The laminar block placed at the main flow channel will also create a very large pressure loss which is very much undesirable for the low flow measurement and yields high energy consumption. The said flow conditioning assembly has a fully symmetrical design. The measurement channel is relatively much larger at the center of the coaxial configuration. The components before the measurement channel are also symmetrical and can be scaled without any impact on the performance. The scalability also allows the said flow conditioning assembly to maintain a small pressure loss.

It is yet another object of the present invention to allow the said flow conditioning assembly to be able to scale up for high flow speed applications such as pneumatic applications. The micromachined flow sensing elements operated with the calorimetric principle are limited for high flow velocity and mass flow measurement because of the boundary conditions. Operating with anemometry may extend to a high flow velocity and mass flow regime but the temperature-related shifting substantially limits the accuracy and impact the capability for low flow measurement. To extend the flow measurement capability to the high flow velocity and mass flow regime, the said flow conditioning assembly offers an alternative flow path that will allow the high flow fluid to pass in the main flow channel while the flow velocity and mass flow in the measurement channel can be proportionally reduced such that the high flow velocity and mass flow measurement can be achieved with the calorimetric sensing measurement. This said alternative flow conditioning assembly has a flow path for high flow velocity and mass flow measurement which utilizes the said flow reprofile disk and profiler design followed by the coaxial flow channel that will not create high flow resistance or pressure loss. The bypass flow measurement channel is designed with an opening on the side wall of the alternative flow conditioning assembly where the flow velocity is the lowest regarding the central flow velocity at the center of the said alternative flow conditioning assembly. Such an opening is designed to have a size at least live to ten times larger than the flow measurement channel size and the opening leads to a belt-like flow channel along the outer surface of the said alternative flow conditioning assembly with a length of more than three-quarter of the outer diameter of the said alternative flow conditioning assembly. The flow measurement block is then connected to the end of the belt-like flow channel. The belt-like flow channel effectively guides the low velocity and mass flow bypass flow into a laminar profile, allowing the flow to maintain excellent reproducibility and hence achieve a high-accuracy flow measurement.

It is another object of the present invention to offer embodiments for the final flow measurement apparatus packages that incorporate the said flow conditioning assembly for both low and high-flow applications. The packaged flow measurement apparatus for low-flow applications can adapt the said flow conditioning assembly with a coaxial flow measurement channel that enjoys a very small pressure loss whilst for the high-flow applications with the same pipework system the said flow conditioning assembly with the circular bypass measurement scheme to maintain the said features and relatively small pressure loss.

Other objects, features, and advantages of the present invention will become apparent to those skilled in the art through the present disclosures detailed herein wherein like numerals refer to like elements.

### BRIEF DESCRIPTIONS OF THE DRAWINGS

FIG. 1A shows the cross-section view of the said flow conditioning assembly integrated into the flow path of a flow measurement apparatus with its components.

FIG. 1B shows the cross-section view of the said flow conditioning assembly from the outlet of the flow path.

FIG. 2A is the closeup view of the key components at the inlet of the said flow conditioning assembly.

FIG. 2B is the closeup view from the flow exit side of the key components of the said flow conditioning assembly.

FIG. 3A is the said alternative flow conditioning assembly with a bypass design for high flow velocity and mass flow measurement apparatus.

FIG. 3B is the view from the outlet of the flow of the said alternative flow conditioning assembly with a bypass design for high flow velocity and mass flow measurement apparatus.

FIG. 3C is the view for the belt-like bypass flow channel on the said alternative flow conditioning assembly for high flow velocity and mass flow measurement apparatus.

FIG. 4 is the schematic view of the bypass measurement arrangement for the said alternative flow conditioning assembly for high-velocity and mass flow measurement.

FIG. 5 is the embodiment of the flow apparatus with the said flow conditioning assembly.

FIG. 6 is the embodiment of the flow apparatus with the said alternative flow conditioning assembly for high flow velocity and mass flow measurement.

FIG. 7 is the comparison of the measurable flow velocity and mass flow for the same-sized main flow channel with the said flow conditioning assembly and alternative flow conditioning assembly.

FIG. 8 exhibits the metrological performance with complicated pipework connected to the inlet of a flow measurement apparatus having the said flow conditioning assembly.

### DETAILED DESCRIPTION OF THE PREFERRED EMBODIMENTS

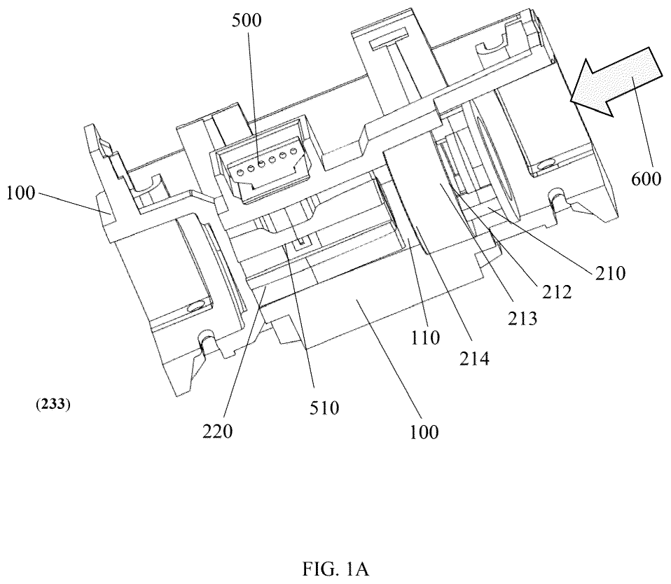

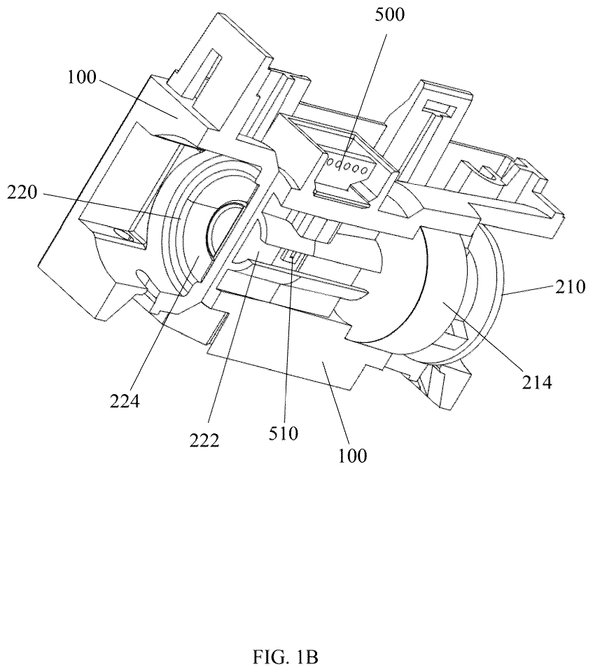

The preferred embodiment of the said flow conditioning assembly for micromachined flow sensing elements with small pressure loss, and high accuracy is shown in FIG. 1A with a view from the inlet and FIG. 1B with a view from the outlet. This said assembly will also remove clogging possibility, allow easy installation without requirements of the inlet conditions, and can be scalable to a large pipework system. The embodiment shows the application for low flow measurement and has the part of the said flow conditioning assembly integrated with the flow apparatus's flow channel and other structural features (100). The incoming flowing fluid will first enter the flow guide ring (210) of the said flow conditioning assembly. The opening of the flow guide ring has the same diameter as a flow shatter disk (212) that is placed after the flow guide ring, and the edge of the disk is open to a chamber (213) behind. The incoming flowing fluid (600) would have an arbitrary profile depending on the inlet connecting pipework conditions but its profile will be shattered by the disk as the flowing fluid will hit directly onto the disk. The flowing fluid is then forced to redistribute along the edge of the disk and populated into the chamber (213) which can also be served as a buffer chamber. The flowing fluid will then continue to enter the flow-reconditioning chamber (214) in which its inlet has a flow straightener and its outlet has a flow profiler. The flowing fluid after this reconditioning process will be guided into the measurement component (220) of the said flow conditioning assembly. Before the measurement component, it is preferred another buffer chamber (110). The measurement component is made of straight pipework that has several coaxial pipes of different sizes (222, 224) in which the micromachined sensing elements (510) are placed on a printed circuitry board (500) and inserted into the central or inner measurement flow measurement channel (222) with the sensing element aligned to the center of the pipe and the surface direction of the sensing elements are perpendicular to the flowing flow direction.

In the preferred embodiment, the redistribution of the incoming flowing fluid that is forced by the guide opening and the flow shatter disk is a critical improvement over the conventional flow conditioning arrangement where only the flow straightener and flow profiler are employed. In a real fluid pipework system, the inlet conditions cannot be controlled well due to various practical reasons and limitations. The straightener could only remove the swirl or turbulent components in the flowing fluid but it cannot control or alter the velocity profile. Subsequently, the profiler placed after the straightener may not effectively manage the profile into the desired one due to the limited spacing between these two. Hence the reproducibility of the flow measurement may not be contained. The disclosed flow shatter disk creates a pressure difference across it and the forced redistribution of the incoming flowing fluid. The altered flow velocity profile combined with the subsequent flow profiler significantly improves the profiling effectiveness. With this capability, the flowing fluid profile after the conditioning is well-defined and reproducible, which allows the micromachined sensing elements to be placed at the main flow channel to capture the data with high repeatability and reproducibility. Subsequently, the mandatory data acquisition with micromachined sensing elements in a tiny bypass channel is no longer the case and key drawbacks of the micromachined sensors with clogging and pressure loss would be eliminated. This forced redistribution of the incoming flowing fluid before it enters the flow straightener and profiler also allows the removal of the inlet connection pipework conditions, and thus normal metrological requirements such as minimal length of the straight pipe, size of the connecting pipework, valve, or pump locations, and elbow pipework location will no longer be needed.

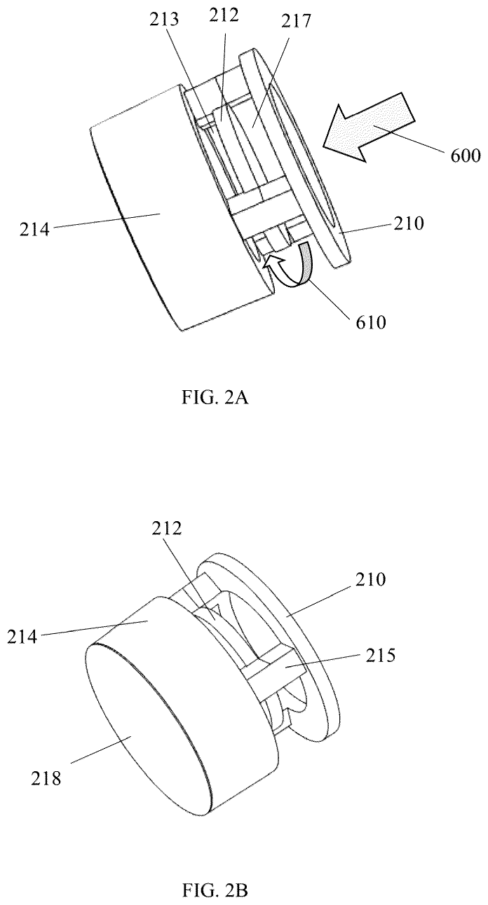

In the preferred embodiment, the closeup views of the key components of the said flow conditioning assembly are shown in FIGS. 2A and 2B. The incoming flowing fluid from the inlet will be shattered by the flow shatter disk (212) after it passes the flow guide ring (210), and the flowing fluid will then continue to flow along the edge of the flow shatter disk (212) as shown by the arrow (610). The redistributed flowing fluid is merged into the buffer chamber or space (213) behind the flow shatter disk (212) before it enters the flow conditioning chamber (214). The opening of the guide ring (210) has preferably the same diameter as the flow shatter disk (212). The outer diameter of the guide ring (210) is the same as the flow channel of the measurement apparatus. The opening of the guide ring is preferably to have a diameter of seven-eighths of that of the flow channel and not to be smaller than five-eighths of that of the flow channel. The thickness of the guide ring (210) and the flow shatter disk (212) is preferably to have a dimension of seven-eighths of diameter for the flow channel and not to be thicker than five-eighths of that for the flow channel. The distance or spacing (217) between the guide ring and the flow shatter disk is preferably three-eight of the diameter of the flow channel but not longer than one-quarter of the diameter of the flow channel. The flow guide ring (210) is preferably supported with three or four equally distributed poles (215) along the wall of the flow channel. The lateral size of the poles will be the same as that of the thickness of the guide ring. The distance or spacing (213) between the flow shatter disk (212) and the flow conditioning chamber (214) is preferably to be one-quarter of the diameter of the flow channel but not to be longer than one-half of the diameter of the flow channel. The spacing (213) will also serve as the buffer space for the shattered and redistributed flowing fluid before it enters the flow conditioning chamber (214). The flow conditioning chamber (214) is made with a cylinder shape with an inner diameter the same as that for the flow channel. A flow straightener and profiler (218) are configured into the best flow conditioning component with the inlet installed with the flow straightener and outlet with the flow profiler. The distance between the straightener and profiler is one-half of the diameter of the flow channel.

In the preferred embodiment, the flow measurement is made possible inside the main flow channel effectively removing the concern for flow clogging and large pressure loss. To achieve the best metrological repeatability and reproducibility, the measurement component (220) is made of coaxial cylinders (222, 224) in which the micromachined sensing elements are placed at the central cylinder that aligns with the center of the flow channel. The length of the component is preferably three to five times the flow channel diameter, but not less than two times the flow channel diameter. This arrangement confines the actual measurement inside a channel with a smaller diameter but with the highest flow velocity in the laminar flow regime leading to the highest sensitivity of the measurement and the largest measurement dynamic range. In the preferred embodiment, the number of coaxial cylinders of the measurement component (220) will be dependent on the flow channel size. The central cylinder diameter is preferably one-eighth to three-eight of the size of the flow channel diameter but not to be more than one-quarter of the flow channel diameter. For a flow channel diameter larger than one inch, the central cylinder diameter will be less than one-quarter inch. The spacing between each coaxial cylinder is preferably equal to that of the central cylinder diameter. The connection between each cylinder will be made preferably with three or four equally distributed thin plates with the same thickness, and the thickness of the plates will be less than three millimeters.

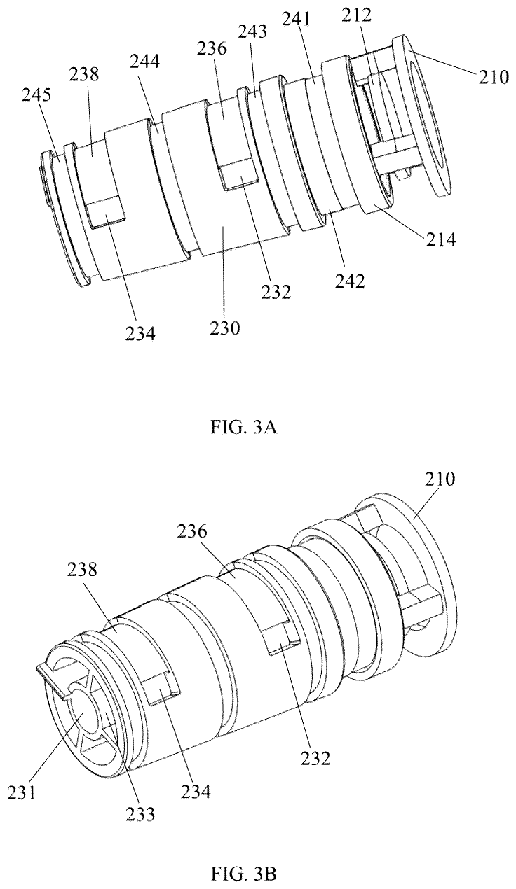

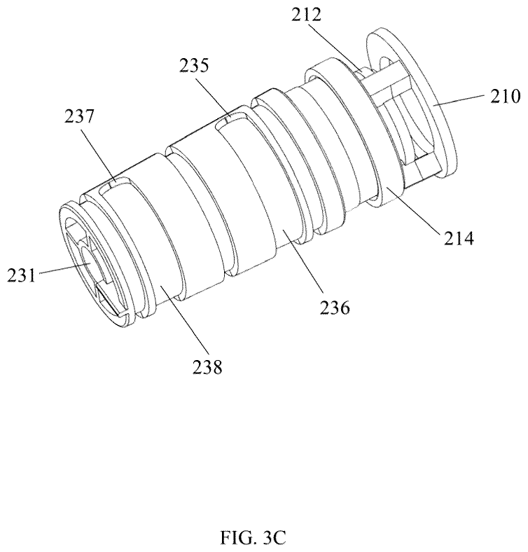

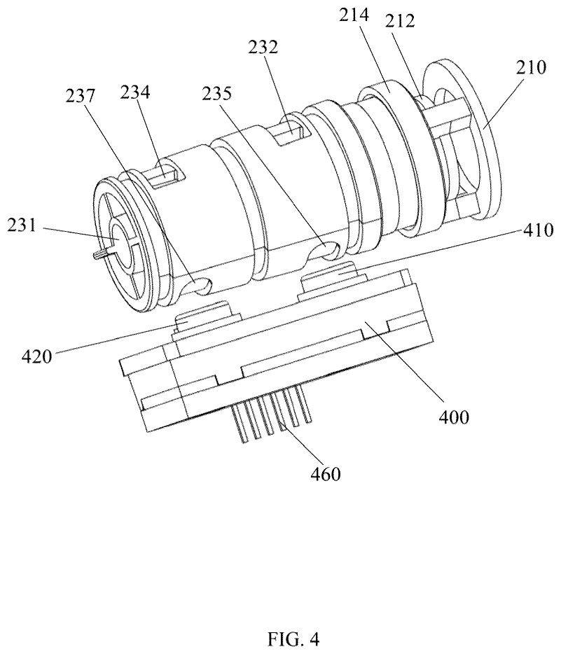

The said flow conditioning assembly allows the micromachined flow sensing elements (510) to be placed at the center of the main flow channel and has the advantage of solving the existing concerns for applications with micromachined sensing elements. Nonetheless, because of the boundary conditions of the calorimetric micromachined sensors, applications for high flow velocity and mass flow measurement become difficult. It is therefore desired to have an alternative design that can accommodate the requirements for high velocity and mass flow measurement. Since the measurement in the main flow channel is no longer possible, bypass design will become inevitable. The bypass design will need to remove the concerns of the same mentioned above for the micromachined sensing elements. FIG. 3A through 3C exhibit a preferred embodiment for the high flow velocity and mass flow measurement. The incoming flowing fluid will be guided via the flow guide ring (210) and its profile will be shattered by the flow shatter disk (212) the flowing fluid will be forced to redistribute along the edge of the flow shatter disk and enter the flow conditioning chamber (214). The subsequent bypass flow chamber (230) is designed to have the main flow channel partitioned with a central cylinder through-flow channel (231) and the coaxial outer cylinder into a ring which is further divided into four equal-sized channels. The flowing fluid in one part of the four in the partitioned ring (233) will have the outlet (232) and inlet (234) opening to the outer water of the bypass flow chamber (230). The flowing fluid flows through the outlet opening (232) and enters a shallow but wide belt-like flow channel (236) which circulates coaxially to the bypass flow chamber (230) in the clockwise direction until it hits the end of the channel (235) where it connects to the inlet (410) of a bypass flow measurement unit (400) shown in FIG. 4. The flowing fluid will be released from the outlet (420) of the bypass flow measurement unit (400). The outlet (420) is connected to the end (237) of a shallow but wide belt-like flow channel (238) leading to the inlet or returning fluid opening (234) on the outer surface of the bypass flow chamber (230). Such a bypass flow chamber can be engaged into the main flow channel of a measurement apparatus by using a few rubber O-rings with their location predefined on the bypass flow chamber (230). Such locations are shown in FIG. 3A by (241, 243, 244, and 245). The circular ring (242) is used to engage the flow conditioning chamber (214) and its width will be dependent on the size of the bypass flow chamber (230).

The bypass flow measurement unit (400) shown in FIG. 4 can be configured as the conventional bypass measurement arrangement where the micromachined flow sensing elements can be placed at the small channel center for which the size of the channel can have a rectangular shape with a dimension that is comparable to that of the micromachined flow sensing elements. The electronics for reading the processing the data from the micromachined sensing elements can be connected via the pin set (460).

In the preferred embodiment, the key feature of the bypass flow chamber (230) is the circular and belt-like flow channels that redistribute the flowing fluid before it enters the inlet (410) of the bypass flow measurement unit (400). In most of the conventional products with a bypass flow measurement unit on the market, the flowing fluid enters the bypass measurement unit directly from the main flow channel leading to uncertainties for repeatability and reproducibility if the flow at the inlet of the main flow channel is not conditioned properly. Further, the small size of the bypass flow channel often will be clogged by particles, oil, or even water vapors. In the said alternative flow conditioning assembly the incoming flowing fluid is first forced to be redistributed with a shattered profile, and after being conditioned by the flow straightener and profiler the circular and belt-like flow channel offers an additional flow profile into a laminar format and hence it can significantly boost the measurement repeatability and reproducibility. The shattering effects of the incoming flowing fluid and the large flow outlet/inlet window (232, 234) also substantially reduce the chance of clogging probabilities. The differential pressure for the bypass flow in the bypass flow chamber (230) is generated with the partitioned main flow channel which has a much smaller pressure loss compared to the laminar block structure used in the conventional bypass flow measurement apparatus. The flow shatter mechanism introduced also relaxes the requirements for the connected pipework system to the inlet of the flow measurement apparatus using the said alternative flow conditioning assembly.

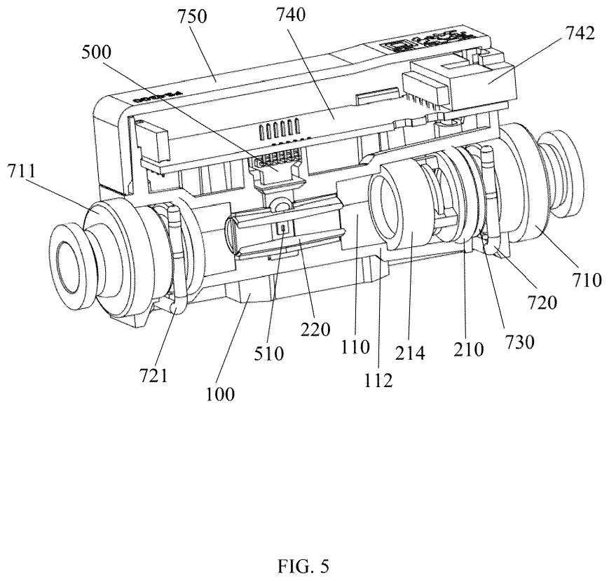

FIG. 5 shows the preferred embodiment of the said flow conditioning assembly arrangement in a flow measurement apparatus. For low-flow measurement applications, the main flow channel and fixtures (100) can be made with a plastic molding process, and the flow measurement component (220) can also be molded into the same part of the main flow channel and fixtures (100). The flow guide ring (210), shatter disk (212), and flow conditioning chamber (214) can be molded as one part as well, and the part can be inserted into the main flow channel where a stop fixture (112) is used to position the part. The connectors to the flow inlet (710) and outlet (711) can be fixed with metal U-pins (720, 721) for easy change with other types of connectors, and in between the U-pin and the flow guide ring (210) a rubber gasket (730) is used for leakage proof. The micromachined sensing elements (510) attached to the printed circuitry board (PCB) (500) can be inserted into the flow measurement component (220). The PCB is connected via a set of pins to the electronic control board (740) where it acquires the data from the micromachined sensing elements (510) and processes the data with the onboard electronics. The electronics interface (742) can be configured into various data transmission formats including wireless data transmission according to the application requirements. The cover (750) protects the electronics from environmental interference and offers other safety protection. This preferred embodiment builds a complete and ready-to-use flow measurement apparatus that offers significant improvement for repeatability and reproducibility of an apparatus using micromachined flow sensing elements for flow measurement. It also provides small pressure loss, prevents clogging, and removes metrological conditions for the connected pipework system at the inlet.

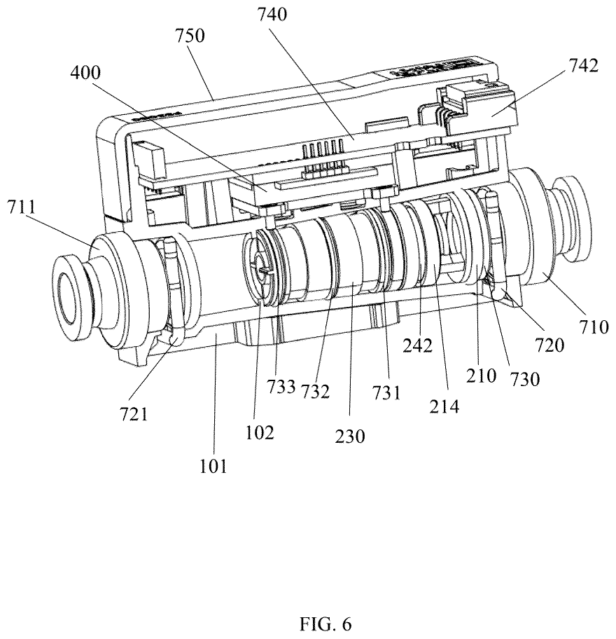

FIG. 6 is the preferred embodiment of the assembly of a flow apparatus using the said alternative flow conditioning assembly with the micromachined flow sensing elements for high flow velocity and mass flow measurement in a small main flow channel. The main flow channel (101) and other fixtures are made with the plastic molding process into a single part. The flow guide ring (210), flow shatter disk (212), and flow conditioning chamber (214) are also molded into a single part. Further, the bypass flow chamber (230) is molded separately into a part as well. In the process of assembling the final flow measurement apparatus, the bypass flow chamber (230) is inserted into the main flow channel first. A stop fixture (102) in the main flow channel (101) is used to position the bypass flow chamber (230). The bypass flow chamber is further engaged and fixed with multiple rubber O-rings (731, 732, and 733). The flow conditioning chamber (214) with the flow shatter disk (212) and flow guide ring (210) is connected to the bypass flow chamber (230) via the engagement circular ring (242). The bypass measurement unit (400) is then installed and fixed to the main flow channel (101) via the pre-molded fixtures. The control electronics printed circuitry board (740) is connected to the bypass measurement unit (400) via a set of pins. The electronic interface connector (742) can be configured into various data transmission formats including wireless data transmission according to the application requirements. The main flow channel inlet and outlet connectors ((710, 711) are fixed with metal U-pins (720, 721) for easy change with other types of connectors, and in between the U-pin and the flow guide ring (210) a rubber gasket (730) is used for leakage proof. The cover (750) protects the electronics from environmental interference and offers other safety protection. This preferred embodiment builds a complete and ready-to-use flow measurement apparatus for high flow velocity and mass flow measurement that offers significant improvement for repeatability and reproducibility of an apparatus using micromachined flow sensing elements for flow measurement. It also provides small pressure loss, prevents clogging, and removes metrological conditions for the connected pipework system at the inlet.

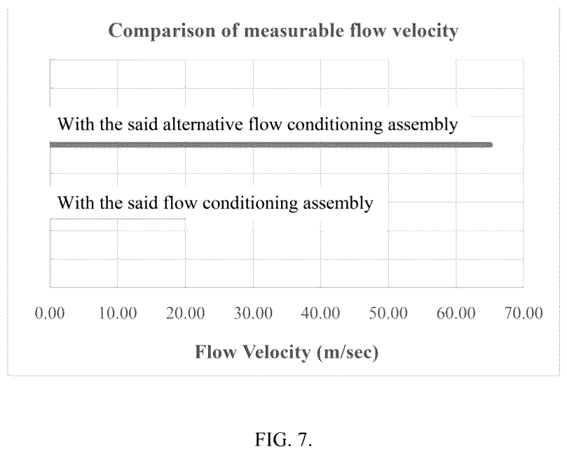

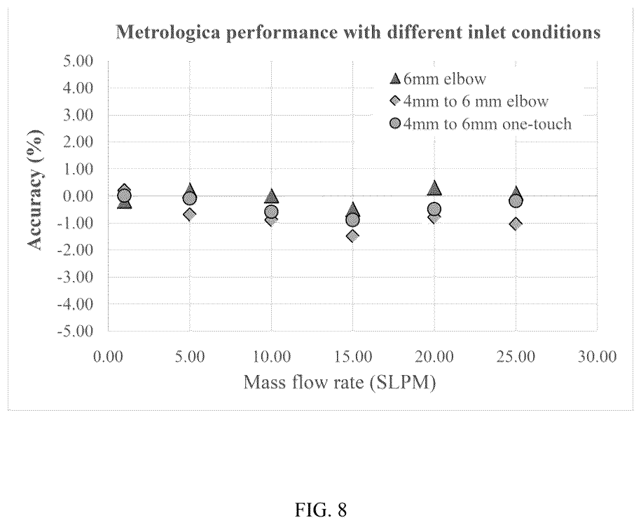

FIG. 7 is the comparison of the measurable flow velocity for the same-sized main flow channel with the said flow conditioning assembly and alternative flow conditioning assembly. The tested data indicated that using the same micromachined flow sensing elements and the said alternative bypass flow conditioning assembly the measurable maximum flow velocity can be extended to about 3.25 times that in which the micromachined flow sensing element is placed at the main flow channel. FIG. 8 exhibits evidence that the said flow conditioning assembly can remove the pipework system requirements while maintaining high precision. As indicated in the graphic dataset the elbow piping or pipework size changes at the inlet do not lead to different accuracies. These types of pipework changes in a conventional flow apparatus are deemed to be catastrophic for the metrological performance.

1. A flow conditioning assembly for a flow velocity and mass flow measurement apparatus utilizing micromachined flow sensing elements comprising:
an incoming flow guide ring;
a flow profile shatter disk;
a buffer chamber;
a flow conditioning chamber having a flow straightener and a flow profiler; and
a flow measurement component with coaxial cylinders;
wherein the micromachined flow sensing elements are placed at a center of a central cylinder,
wherein the flow conditioning assembly is able to maintain metrological repeatability and reproducibility while having a small flow resistance or a pressure loss, and
wherein the flow conditioning assembly is able to significantly reduce a chance of flow clogging and ease the requirements for a pipework system that is connected to the flow measurement apparatus.

2. The flow conditioning assembly of claim 1, wherein the flow guide ring has its outer diameter identical to that of a main flow channel, its central circular opening size is one-eighth of the outer diameter but not larger than one-half of its outer diameter, and most preferably to be one-eighth of its outer diameter, thickness of the flow guide ring is preferably one-eighth to one-quarter of the flow channel diameter, and most preferably one-eighth of the main flow channel diameter.

3. The flow conditioning assembly of claim 1, wherein the flow shatter disk has an identical size to the flow guide ring opening, thickness of the flow shatter disk is preferably one-eighth to one-quarter of the flow channel diameter, and most preferably one-eighth of the flow channel diameter, the buffer chamber behind the flow shatter disk has a length of three to three-quarters of the flow channel diameter but preferably one-half of the main flow channel diameter.

4. The flow conditioning assembly of claim 1, wherein the flow conditioning chamber is placed after the buffer chamber behind the flow shatter disk, the flow conditioning chamber preferably has the same size as the main flow channel diameter with a preferable length of one-quarter to three-quarter of the main flow channel diameter, and most preferably one-half of the flow channel diameter.

5. The flow conditioning assembly of claim 1, wherein the flow conditioning chamber preferably has the flow straightener installed at an inlet of the flow conditioning chamber and the flow profiler installed in parallel at an outlet of the flow conditioning chamber, with a distance in between most preferably one half of the flow channel diameter.

6. The flow conditioning assembly of claim 1, wherein the flow measurement component is placed in the main flow channel of the flow measurement apparatus behind the flow conditioning chamber, a distance between the flow conditioning chamber and the flow measurement component is preferably one-quarter to three-quarters of the main flow channel diameter and most preferably one-half of the flow channel diameter.

7. The flow conditioning assembly of claim 6, wherein the flow measurement component is including coaxial cylinders, a central cylinder is designed as a flow measurement channel in which the micromachined flow sensing element is placed at a tip of a thin rectangular printed circuitry board that inserts into a center of the measurement channel and aligns in parallel to a flow direction such that the surface direction of the micromachined flow sensing element is perpendicular to the flow direction.

8. The flow conditioning assembly of claim 7, wherein the flow measurement channel diameter is preferably one-eighth to one-half of the main flow channel diameter, most preferably one-quarter of the main flow channel diameter, a space between the coaxial cylinders is preferably one-eighth to one-half of the flow channel diameter, most preferably one-quarter of the flow channel diameter, the coaxial cylinders are preferably connected via thin plates along radius of the flow measurement channel and evenly distributed inside the measurement component, thicknesses of these plates are preferably within two millimeters and the numbers of such plates are preferably to be three.

9. The flow conditioning assembly of claim 7, wherein the micromachined flow sensing element carrier printed circuit board has a thickness of equal or less than one millimeter, and most preferably five-eighths millimeter.

10. An alternative flow conditioning assembly for a high flow velocity and mass flow measurement apparatus utilizing micromachined flow sensing elements comprising:
an incoming flow guide ring;
a flow profile shatter disk;
a buffer chamber;
a flow conditioning chamber having a flow straightener and a flow profiler;
a bypass flow measurement unit; and
a bypass flow chamber that is connected to the bypass flow measurement unit;
wherein the alternative flow conditioning assembly offers a solution for high flow velocity and mass flow measurement while maintaining metrological repeatability and reproducibility,
wherein the alternative flow conditioning assembly has a small flow resistance or pressure loss, and
wherein the alternative flow conditioning assembly significantly reduces the chance of flow clogging and eases the requirement for a pipework system that is connected to a flow measurement apparatus.

11. The alternative flow conditioning assembly of claim 10, wherein the flow guide ring, the flow shatter disk, and the flow conditioning chamber are identical to those in claim 2, 3, 4, and 5.

12. The alternative flow conditioning assembly of claim 10, wherein the bypass flow chamber is placed in a main flow channel and is made with coaxial cylinders in which a central cylinder that aligns to a central axis of the main flow channel is preferably one-eighth to one-half of the main flow channel diameter but most preferably one-quarter of the main flow channel diameter, the spacing between the coaxial cylinders is preferably one-eighth to one-half of the main flow channel diameter but most preferably one-quarter of the flow channel diameter.

13. The alternative flow conditioning assembly of claim 12, wherein the coaxial cylinders of the bypass flow chamber are preferably connected via thin plates along the radius of the bypass flow chamber and evenly distributed inside the measurement component. The thicknesses of these plates are preferably within two millimeters and most preferably one millimeter. The number of such plates is preferably to be three or four, but most preferably to be four.

14. The alternative flow conditioning assembly of claim 12, wherein two openings are made on the outer wall of the bypass flow chamber, one opening upstream of the bypass flow chamber allows the flow to exit to the bypass flow measurement unit whilst another downstream allows the flow to return to the bypass flow chamber, size of the opening is preferably one-sixteenth to one-quarter of the flow channel diameter but most preferably one-eighth of the flow channel diameter, shape of the openings can be rectangular or circular, but preferably to be rectangular, distance between the two openings is preferably to be half to two times the flow channel diameter but most preferably to be one time the flow channel diameter.

15. The alternative flow conditioning assembly of claim 12, wherein at an outer surface of the bypass flow chamber, two flow redistribution channels are arranged to connect to the two openings at the wall, each channel is made along the perimeter of the bypass flow chamber's outer surface, width of the channel is made to be same as the openings' dimension perpendicular to the perimeter of the bypass flow chamber, height of the channel is preferably to be one-thirty-two to one-eighth of the bypass flow channel diameter by preferably sixteenth of the bypass flow channel diameter, length of the channel is preferably one-third to four-fifths of the perimeter of the bypass flow chamber, but most preferably three-quarters of the perimeter of the bypass flow chamber.

16. A flow measurement apparatus utilizing the micromachined flow sensing elements for low flow velocity and mass flow measurement comprising:
a main flow channel;
a flow conditioning assembly which is installed into the main flow channel;
a micromachined flow sensing element chip placed on a carrier printed circuitry board which is installed into the flow conditioning assembly;
a control electronic printed circuitry board that connects to the carrier printed circuitry board;
an electronic communication interface installed on the control electronics printed circuitry board;
an inlet and an outlet connector fixed with a U-pin, respectively; and
a cover protects the electronics.

17. A flow measurement apparatus utilizing the micromachined flow sensing elements for high flow velocity and mass flow measurement, comprising a main flow channel;
an alternative flow conditioning assembly is installed into the main flow channel;
a micromachined flow sensing element chip placed in a bypass flow measurement unit which is connected to openings on the bypass flow chamber;
a control electronic printed circuitry board that connects to the bypass flow measurement unit;
an electronic communication interface installed on the control electronics printed circuitry board;
an inlet and an outlet connector fixed with a U-pin, respectively; and
a cover protects the electronics.
